(19) United States
(12) Patent Application Publication
(10) Pub. No.: US 2019/0035006 A1
(43) Pub. Date: Jan. 31, 2019

(54) COMMERCE FACILITATION SYSTEM

(71) Applicants: Alexis Skogsberg, Fort Worth, TX (US); Chad Skogsberg, Fort Worth, TX (US)

(72) Inventors: Alexis Skogsberg, Fort Worth, TX (US); Chad Skogsberg, Fort Worth, TX (US)

(21) Appl. No.: 16/048,214

(22) Filed: Jul. 27, 2018

Related U.S. Application Data
(60) Provisional application No. 62/537,700, filed on Jul. 27, 2017.

(51) Int. Cl. G06Q 30/06; G06K 9/00; G06Q 30/04

(52) U.S. Cl. CPC G06Q 30/0641; G06Q 30/04; G06K 9/00671; G06Q 30/0603

(57) ABSTRACT

A commerce facilitation system enables the seamless purchase of available products as displayed on the screen of a digital device. A portal uses an image capture of a posted product to access an identifier of the product so that an invoice for the product is transmitted directly to the user upon creating of the image capture.

### BACKGROUND

### 1. Field of the Invention

The present invention relates generally to electronic transaction systems, and more specifically, to a commerce facilitation system for simplifying and streamlining the process of creating and authorizing a purchase.

### 2. Description of Related Art

Electronic transaction systems are well known in the art and are effective means to market and distribute products through a digital network such as social media. For example, FIG. 1 depicts a conventional product posting 101 having a picture of a product 103 that is published by a website 105 that could have additional descriptions 107. During use, the posting 101 is viewed by a prospective buyer 113 who then identifies the seller 109 of the pictured product 103 and navigates to the seller's website 111 where they can locate and purchase the product 103.

One of the problems commonly associated with system 101 is its limited efficiency. For example, a user must identify the seller 109 then locate their website 111 and then relocate the product 103 they wish to purchase.

Accordingly, although great strides have been made in the area of product postings 101, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a common product posting;

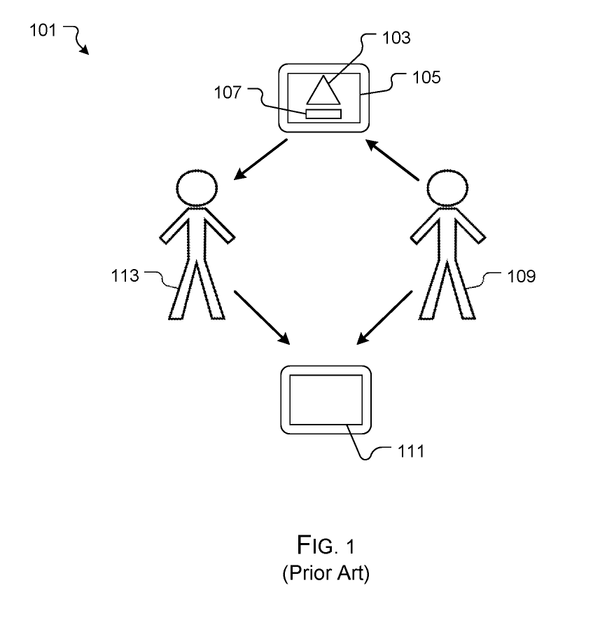

FIG. 2 is a simplified schematic of a commerce facilitation system in accordance with a preferred embodiment of the present application;

FIG. 3 is a diagram of the portal of FIG. 2;

FIG. 4 is a flowchart of the preferred method of use of the system of FIG. 2; and

FIG. 5 is a diagram of an alternative embodiment of the portal of FIGS. 2 and 3.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional product postings. Specifically, the invention of the present application enables a user to directly purchase a product found in a picture from the location of the picture. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

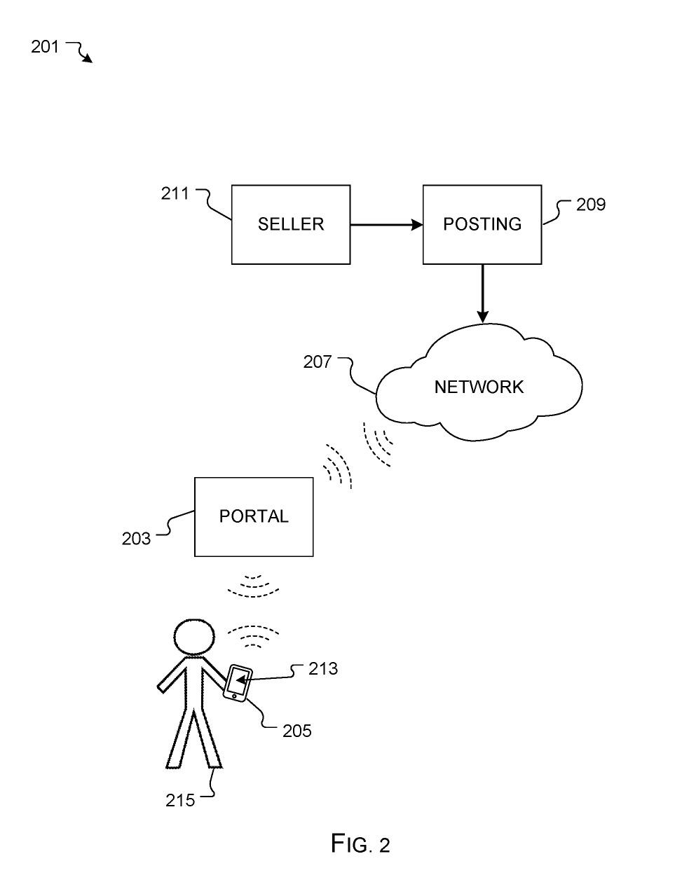

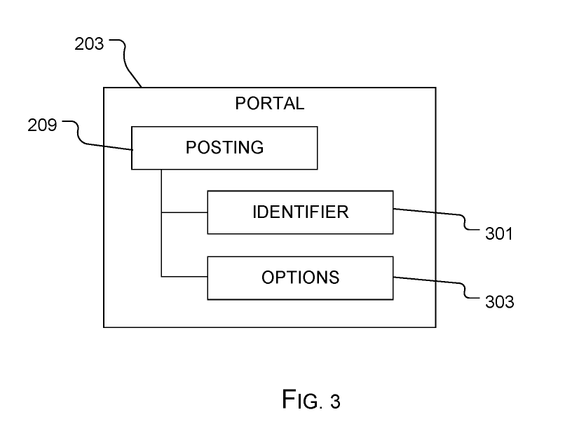

Referring now to the drawings wherein like reference characters identify corresponding or similar elements throughout the several views, FIGS. 2 and 3 depict a simplified schematic of a commerce facilitation system and a portal respectively in accordance with a preferred embodiment of the present application. It will be appreciated that system 201 overcomes one or more of the above-listed problems commonly associated with conventional product postings.

In the contemplated embodiment, system 201 includes a portal 203 in electronic communication with a digital device 205 and a network 207. Wherein the portal 203 is configured to capture an image of what is displayed on the screen 213 of the digital device 205.

The network 207 having a posting 209 of a potential product available for purchase from a seller 211. The postings 209 is transmitted via the network to the digital device 205.

The portal 203 being configured to monitor the posting 209 displayed by the digital device 205, so that when an image is captured the portal 203 is aware of the product of the posting 209. The posting 211 having an identifier 301 configured so that the product of the posting 209 is known to the portal 203. The identifier 301 linking the available options 303 for the product such as size, color or the like. It is contemplated that the identifier 301 could be created by the seller 211, the posting 209 or the portal 203.

In use, the posting 209 is created by the seller 211 or another party. A user 215, accesses the posting 209 via the digital device 205 and network 207. An image is captured of a posting 209 that the user 215 wishes to purchase the portal 203 generates an invoice which is transmitted to the user 215. The invoice contains the options 303 so that the user 215 is able to approve the transaction with the selected options 303.

It should be appreciated that one of the unique features believed characteristic of the present application is that portal 203 enables the direct purchase of a product displayed on the digital device 205. It will also be appreciated that the identifier 301 could be the image of the product in the posting 209, a hashtag, an assigned code or the like.

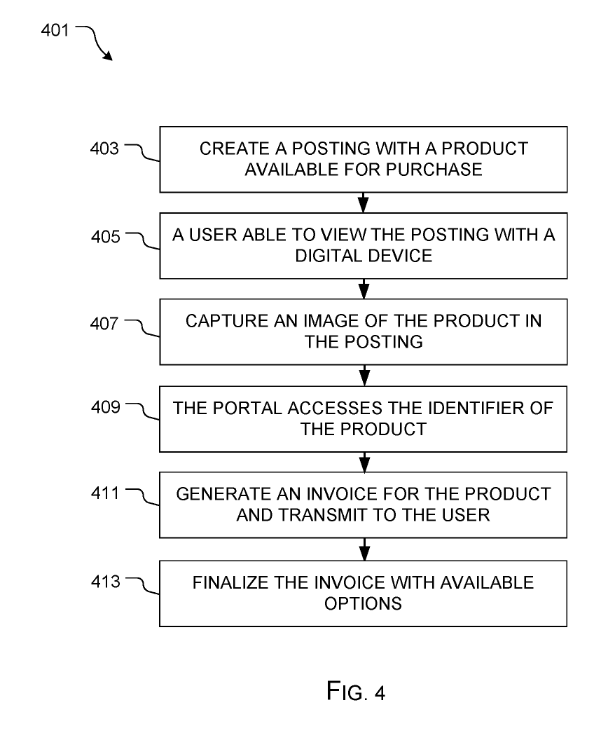

Referring now to FIG. 4 a flowchart of the preferred method of use of the system 201 is depicted. Method 401 including creating a posting with a product available for sale 403, a user viewing the posting with a digital device 405, capturing an image of the product in the posting 407, accessing the identifier of the product 409, generating an invoice for the product that is transmitted to the user 411 and finalizing the invoice with the available options 413.

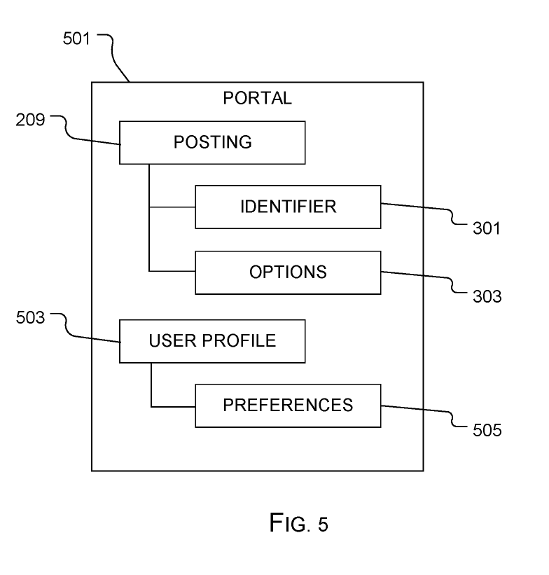

Referring now to FIG. 5 an alternative embodiment of the portal 203 is depicted. Embodiment 501 having the same features and the portal 203 with the addition of a user profile 503. The profile having preferences 505 of the user 215. The preferences 505 could be the user's size or preferred colors. It will be appreciated that the profile 503 enables the instant purchase of the product of the posting 209 by supplying the required options without need for repetitive user input.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A commerce facilitation system comprising:
a user with a digital device viewing at least one posting wherein a product is available for purchase;
a portal through which an image capture of the product accesses an identifier for that product;
wherein the portal generates an invoice for the product with any options that is transmitted directly to the user.

2. The portal of claim 1 wherein the user creates a profile that contains input for the options of the product; wherein the product is directly purchases without the need to verify the invoice and input options.

3. A method of facilitating a commercial transaction given the system of claim 1, comprising:
creating a posting with a product available for sale;
a user viewing the posting with a digital device;
capturing an image of the product in the posting;
the portal accessing the identifier of the product;
generating an invoice for the product that is transmitted to the user; and
finalizing the invoice with the available options.
